(19) United States
(12) Patent Application Publication
(10) Pub. No.: US 2014/0246961 A1
(43) Pub. Date: Sep. 4, 2014

(54) ENERGY TRANSFER SYSTEM AND METHOD

(71) Applicant: Stephen Smith, Essex Fells, NJ (US)

(72) Inventor: Stephen Smith, Essex Fells, NJ (US)

(21) Appl. No.: 14/174,101

(22) Filed: Feb. 6, 2014

Related U.S. Application Data
(63) Continuation of application No. 13/783,523, filed on Mar. 4, 2013.

(51) Int. Cl. H02K 7/00

(52) U.S. Cl. CPC H02K 7/003
USPC 310/75 R

(57) ABSTRACT

An energy transfer system has a sender with at least one local permanent magnet or other magnetic device for producing a magnetic field along a magnetic axis that is transverse to the sender's axis. The sender can rotate the magnetic field about the sender's axis. An armature that is coaxial (or skewed) with and axially spaced from the sender has at least one remote permanent magnet or other magnetic device for interacting with the magnetic field. The remote magnetic device has a magnetic axis that is transverse to the armature's axis of rotation. The armature can be angularly driven in response to rotation of the magnetic field from the sender. One or more windings are mounted about the armature and magnetically link with the remote magnetic device. A current is induced in the winding (or windings) in response to rotation of the armature and its magnetic device. This allows transmission through an optional non-ferromagnetic barrier that separates and extends transversely between the sender and armature.

### BACKGROUND OF THE INVENTION

1 Field of the Invention

The present invention relates to energy transfer system, and in particular, to electromagnetic machines for generating current.

2. Description of Related Art

In some cases power must be conveyed across an air gap or through a barrier. For example, one may wish to charge a battery surgically implanted inside a person's body. In other cases one may wish to charge an electronic device (e.g. a cell phone or portable computer) without using a connector. In still other cases one may wish to charge a battery in an electrically driven automobile.

When it is inconvenient or impossible to make an ohmic connection, some known systems have used simple transformer principles to convey electrical energy. A transformer-like energy transfer may, however, be inefficient when the primary and secondary coils cannot be placed close together. Then, energy transfer is limited by the fact that the magnetic field intensity can drop as the inverse square of distance (or as the inverse cube for greater distances where the primary acts more like a dipole).

In electromagnetic machines Faraday's and Lenz's law indicate that the electromotive force (EMF) in a coil of wire will be proportional to the rate of change of magnetic flux through the coil times the number of turns in the coil. Thus, one can rotate a coil of wire through a static magnetic field to create an alternating current, that is to act as an AC generator.

Equivalently, a coil placed near a rotating permanent magnet can link with this time-varying field to generate AC. In some cases the permanent magnet can be replaced with an electromagnet powered by an external current. While a single coil may be used, in most cases a pair of coils positioned on opposite sides of the axis of rotation will be connected in parallel or series to reinforce each other. Three phase machines may use three pairs of coils.

Where direct current (DC) is desired a commutator (electronic, or one using slip brushes) can select angularly spaced coils just as each is driven to peak EMF.

Magnetic clutches are used to transfer a torque from an input to output shaft by using the force of magnetic attraction. In some cases permanent magnets will be placed in close proximity to create the magnetic attraction, although in other instances the permanent magnets on the input and/or the output side can be replaced with an electromagnet energized by an external current. The clutch can be built as a pair of nested cylindrical drums, or as an opposing pair of parallel disks, separated by an air gap in either case.

See also U.S. Pat. Nos. 2,350,534; 3,683,249; 4,035,658, 4,266,914; 4,464,579; 5,586,823; 6,380,653; 6,977,454; 7,313,840; 8,167,063, as well as US Patent Application Publication Nos. 2008/0024035 and 2012/0126539.

### SUMMARY OF THE INVENTION

In accordance with the illustrative embodiments demonstrating features and advantages of the present invention, there is provided an energy transfer system having a sender and an armature. The sender has at least one local element for producing a magnetic field. The magnetic field can be rotated by the sender. The armature has at least one remote element for interacting with the magnetic field. The armature is arranged to be angularly driven in response to rotation of the magnetic field. The system also includes at least one winding disposed about the armature for interacting with the at least one remote element. A current is induced in the at least one winding in response to rotation of the armature and the at least one remote element.

In accordance with another aspect of the invention, there is provided a method employing a winding and a local and a remote element for transferring energy. The method includes the step of using the local element to send a rotating magnetic field. Another step is placing the remote element in a position to be angularly driven by the rotating magnetic field. The remote element is axially spaced from the local element. The method also includes the step of disposing the winding about the remote element in a position to induce a current in the winding in response to rotation of the remote element.

In accordance with yet another aspect of the invention, there is provided an energy transfer system having a rotor and an armature. The rotor has a local axis of rotation, and carries at least one local permanent magnet for producing a magnetic field. The local permanent magnet has a magnetic axis that is transverse to the local axis of rotation. The magnetic field can be rotated by the rotor. The armature is axially spaced from the rotor and has at least one remote permanent magnet for interacting with the magnetic field. The armature has a remote axis of rotation aligned with the local axis of rotation. The remote permanent magnet has a magnetic axis that is transverse to the remote axis of rotation. The armature is arranged to be angularly driven in response to rotation of the magnetic field. The system also includes an angularly spaced plurality of windings mounted about the armature to magnetically link with the remote permanent magnet. A current is induced in the plurality of windings in response to rotation of the armature and the at least one remote permanent magnet. The system may include a non-ferromagnetic barrier separating and extending transversely between the sender and the armature.

In a disclosed embodiment a sending rotor has a stack of permanent magnets oriented with a magnetic axis perpendicular to a driving shaft. A complementary armature is built with a similar stack of permanent magnets, again having a magnetic axis perpendicular to the armature's axis of rotation.

The rotor and armature can be separated axially or radially, but will still maintain a magnetic attraction between them. With a sufficiently strong magnetic attraction, rotation of the rotor will cause synchronous rotation of the armature. Accordingly, the armature can be rotated without a hard mechanical linkage and can thus transmit a torque through an air gap or through a barrier.

Advantage is then taken of the rotation of the permanent magnets of the armature. Specifically, coils placed around the armature link with its rotating field to generate AC.

Embodiments are disclosed where the armature can cooperate with a single winding or a plurality of windings. Also disclosed is an armature with an equiangularly spaced plurality of permanent magnets, some pairs of magnets having magnetic axes in opposition and other pairs having transverse magnetic axes.

In some embodiments the sending rotor and the armature will have aligned axes of rotation, and each will have a magnetic axis transverse to this axis of rotation. In other cases the axes of rotation will not be aligned, but may be skewed, and/or radially displaced. For some embodiments, the sending rotor and armature will have aligned axes of rotation, but the sending rotor will have a plurality of magnetic elements with magnetic axes that are parallel to this axis of rotation, and poled in opposite directions. In still other embodiments, the sending rotor and the armature will be essentially coplanar and have radially spaced, parallel axes of rotation with a magnetic field transverse to each axis.

In another disclosed embodiment, the armature will be a magnetic ball (a spherical permanent magnet) mounted with freedom of movement inside the hollow core of a spool that supports a winding that encircles the ball. An external, alternating magnetic field is applied to the ball, which will flip its magnetic axis every time the applied field reverses. For practical embodiments, the field frequency and the mass of the ball will cause the ball to rotate in the same direction along an axis that is transverse to the ball's magnetic axis.

Stationary electromagnets can be used in place of a rotor that moves one or more permanent magnets. The disclosed stationary electromagnets are equiangularly distributed around a central axis and are grouped in diametrically opposed pairs. Three pairs are disclosed, which are designed to receive three-phase power, one phase for each pair. The electromagnets each produce an effect that is superimposed with the effects of the other electromagnets to produce a rotating magnetic field transverse to the central axis. I

### BRIEF DESCRIPTION OF THE DRAWINGS

The above brief description as well as other objects, features and advantages of the present invention will be more fully appreciated by reference to the following detailed description of illustrative embodiments in accordance with the present invention when taken in conjunction with the accompanying drawings, wherein:

FIG. 1 is a perspective view of an energy transfer system in accordance with principles of the present invention;

FIG. 2 is an axial view, partly in section, of the armature and windings of FIG. 1;

FIG. 3 is a schematic diagram showing the magnetic coupling for the system of FIG. 1;

FIG. 4 is an assembled, perspective view of the system of FIG. 1;

FIG. 5 is an axial view of an armature and windings that is an alternate to that of FIG. 2;

FIG. 6 is a side view of the armature and winding of FIG. 5;

FIG. 7 is an axial view of an armature and windings that is an alternate to that of FIGS. 2 and 5;

FIG. 8 is an axial view of an armature that is an alternate to those previously illustrated;

FIG. 9 is an axial view of an armature and windings that is an alternate to those previously illustrated; and

FIG. 10 is a schematic diagram showing an energy transfer system that is an alternate to that of FIG. 1;

FIG. 11 is perspective view of an energy transfer system that is an alternate to those previously illustrated;

FIG. 12 is a schematic diagram showing the magnetic coupling for the system of FIG. 11;

FIG. 13 is a partly exploded, perspective view of an armature and winding that is an alternate to those previously illustrated;

FIG. 14 is a schematic diagram showing the magnetic coupling for the armature and winding of FIG. 13 when driven by the sender of FIG. 11;

FIG. 15 is a perspective view of a sender employing electromagnets, which is an alternate to the senders previously illustrated; and

FIG. 16 is a wiring diagram for the sender of FIG. 15.

### DETAILED DESCRIPTION

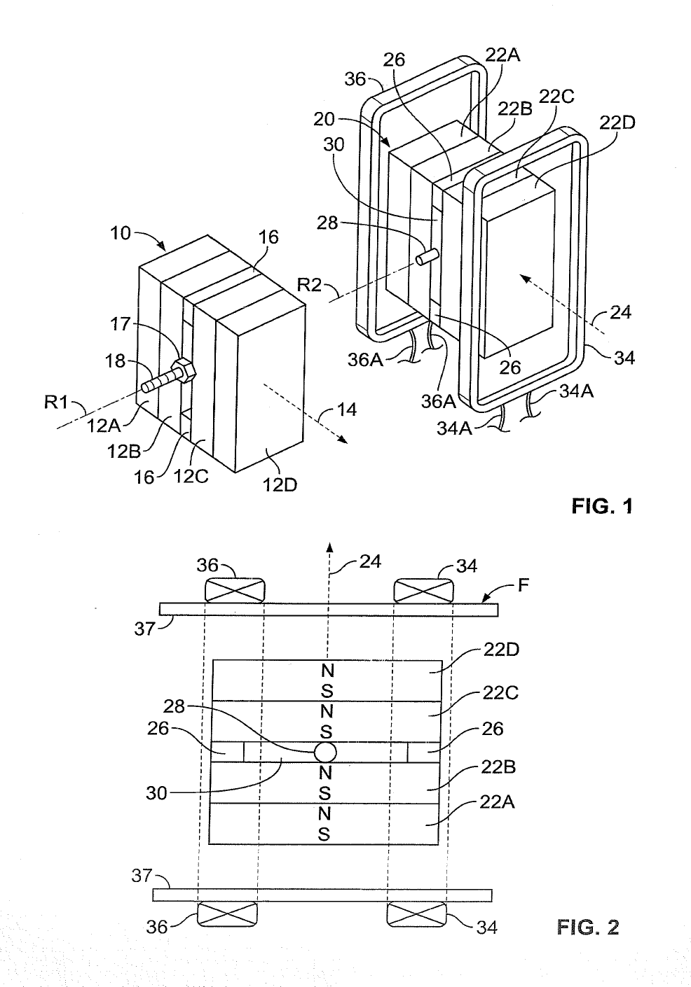

Referring to FIGS. 1-3 the illustrated energy transfer system employs a sender in the form of rotor 10. Rotor 10 is shown with a stack of four local permanent magnets 12A, 12B, 12C and 12D (collectively magnets 12). Magnets 12 are reinforcing and each have their north pole facing in the direction indicated by magnetic axis 14. Local magnets 12 are also referred to herein as local elements.

Magnets 12A and 12B are a contiguous stack, as are magnets 12C and 12D. Magnets 12A and 12B are separated from magnets 12C and 12D by spacers 16 made of cardboard, steel or other material. While magnets 12 and spacers 16 can be secured together by adhesives or other mechanical fastening means, in this embodiment their magnetic attractive force is sufficient to keep them locked together.

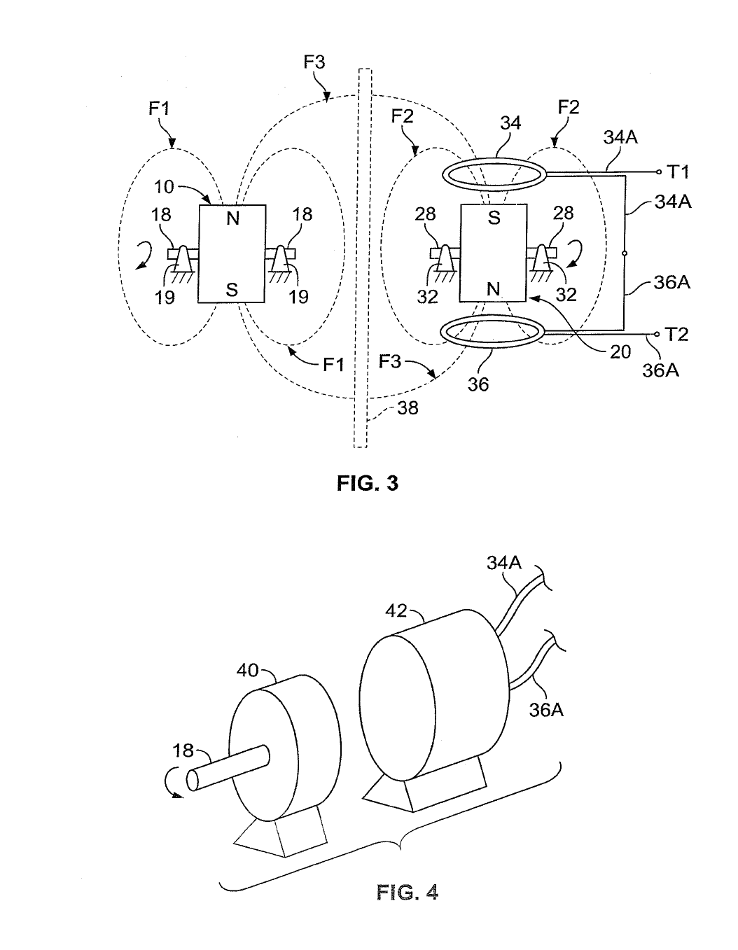

Threaded shaft 18 is inserted between magnets 12B and 12C and held in a central location with an opposing pair of nuts 17, one being visible in FIG. 1. Rotor 10 can rotate on shaft 18 about the local axis of rotation R1, supported by bearing blocks 19 FIG. 3. Magnetic axis 14 is transverse to axis of rotation R1.

Armature 20 is shown with a stack of four remote permanent magnets 22A, 22B, 22C and 12D (collectively magnets 22). Magnets 22 are reinforcing and each have their north pole facing in the direction indicated by magnetic axis 24. Remote magnets 22 are also referred to herein as remote elements.

Magnets 22A and 22B are a contiguous stack, as are magnets 22C and 22D. Magnets 22A and 22B are separated from magnets 22C and 22D by spacers 26 made of cardboard, steel or other material. Axle 28 is integrally attached to rectangular blade 30, which is located between spacers 26. In this embodiment magnets 12 and spacers 16 are secured together by adhesives, although other mechanical fastening means may be employed and the integrity of the assembly will be reinforced by the magnetic attractive force of the magnets 22.

Armature 20 can rotate on axle 28 about the remote axis of rotation R2, supported by bearing blocks 32 (FIG. 3). Magnetic axis 24 (FIG. 1) is transverse to axis of rotation R2. In this embodiment the axes of rotation R1 and R2 are aligned, although in some embodiments they may be somewhat offset radially or skewed at a small angle. Also, armature 20 is axially spaced from rotor 10.

In particular, “skewed” axes as used herein means: (a) if the axes are coplanar, they are neither parallel nor perpendicular, or (b) if the axes are not coplanar, a perpendicular projection of one onto the other is neither parallel not perpendicular.

A pair of windings 34 and 36 are each wound in parallel planes that are equidistantly spaced from axis R2. Windings 34 and 36 are coaxial and angularly spaced 180° with respect to axis R2. Windings 34 and 36 are formed into approximately rectangular loops with rounded corners that are both large enough to encircle portions of armature 20 as it rotates through the windings. Windings 34 and 36 are connected in series through their leads 34A and 36B, respectively, as shown FIG. 3, although in some embodiments they may be connected in parallel.

Windings 34 and 36 may be supported on a scaffold-like frame F (FIG. 2) that encompasses armature 20. Unlike a conventional stator, this frame will not encircle armature 20 with a high permeability annulus, which might defeat magnetic coupling between rotor 10 and armature 20. In this embodiment frame F is an open lattice with non-ferromagnetic bars 37 arranged in the pattern of a rectangular parallelepiped (i.e. twelve bars). Four of those bars extend from the inside corners of winding 34 to the complementary inside corners of winding 36. Two of these bars 37 are shown in FIG. 2. These four corner bars 37 are supported by the other bars (not shown) of frame F.

Rotor 10 and armature 20 are not linked with a hard mechanical linkage and are shown in FIG. 3 separated by non-ferromagnetic barrier 38. Referring to FIG. 4, rotor 10 is mounted inside housing 18 with its shaft 18 protruding therefrom. Also, armature 20 and windings 34 and 36 are mounted inside housing 42 with previously mentioned leads 34A and 36A extending from the housing. To promote magnetic coupling in a manner to be described presently, housings 40 and 42 are non-ferromagnetic, at least for adjacent portions of these housings.

To facilitate an understanding of the principles associated with the foregoing apparatus, its operation will be briefly described. Rotor 10 and armature 20 will initially align as shown in FIGS. 1 and 3. Specifically, the magnetic axes 14 and 24 will be anti-parallel, that is, parallel but pointing in opposite directions. As shown in FIG. 3, the north pole of rotor 10 is pointing up while the north pole of armature 20 is pointing down, that is, an alignment to be expected with ordinary magnetic attraction.

Lines of flux F1 are shown making a circuit between the north and south poles of permanent magnet 10. Likewise, lines of flux F2 are shown making a circuit between the north and south poles of permanent magnet 20. Moreover, some lines of flux F3 link between both magnets 10 and 20, making a circuit that includes a link between (1) the north pole of magnet 10 and the south pole of magnet 20, and (2) the north pole of magnet 20 and the south pole of magnet 10.

Next, shaft 18 will be rotated by an external mechanical power source (not shown), such as a hand crank, a motor (diesel, gasoline, electrical, etc.), a windmill, a steam turbine, etc. Consequently, the magnetic axis 14 of permanent magnet 10 will rotate to produce a rotating magnetic field that causes flux lines F1 and F3 to rotate about the axis of rotation R1. This rotating magnetic field produces a torque on permanent magnet 20, causing it to rotate about axis R2. Provided the magnetic fields of magnets 10 and 20 are strong enough, both magnets will rotate at the same speed without slippage, but with a phase angle differential sufficient to produce the driving torque.

With magnets 10 and 20 rotating, flux lines F1, F2 and F3 will rotate as well relative to stationary windings 34 and 36. Faraday's and Lenz's law indicate that the electromotive force (EMF) in windings 34 and 36 will be proportional to the rate of change of magnetic flux through the coil, times the number of turns in the coil. As flux lines F2 and F3 rotate, the linkage through windings 34 and 36 will periodically reverse and produce a sinusoidal EMF. Therefore, the foregoing arrangement will act as an efficient AC generator with the current induced in windings 34 and 36 supplying electrical power to terminals T1 and T2 (FIG. 3).

The magnetic linkage between magnet 10 and windings 34 and 36 (flux lines F3) is a relatively small percentage of the total magnetic linkage through those windings. As suggested by FIG. 3 the linkage from magnet 20 involves a relatively high flux density (flux lines F2) compared to that from magnet 10 (flux lines F3). Because magnet 20 is adjacent to windings 34 and 36 and rotates synchronously with magnet 10, magnet 20 effectively magnifies the magnetic flux produced by magnet 10. Greater electrical power is produced as a result of this magnified flux density.

Moreover, transferring energy by rotation of magnetic field F3 enables an efficient power transfer without a hard mechanical linkage. So, for example, power can be conveyed through an air gap between the spaced housings 40 and 42 (FIG. 4). Alternatively, power can be conveyed through a non-ferromagnetic wall such as a residential window or a fish tank. This principle can be used to convey power to a battery without needing to use electrical connectors. This can be useful for charging batteries contained inside a portable electronic device or inside a human body cavity.

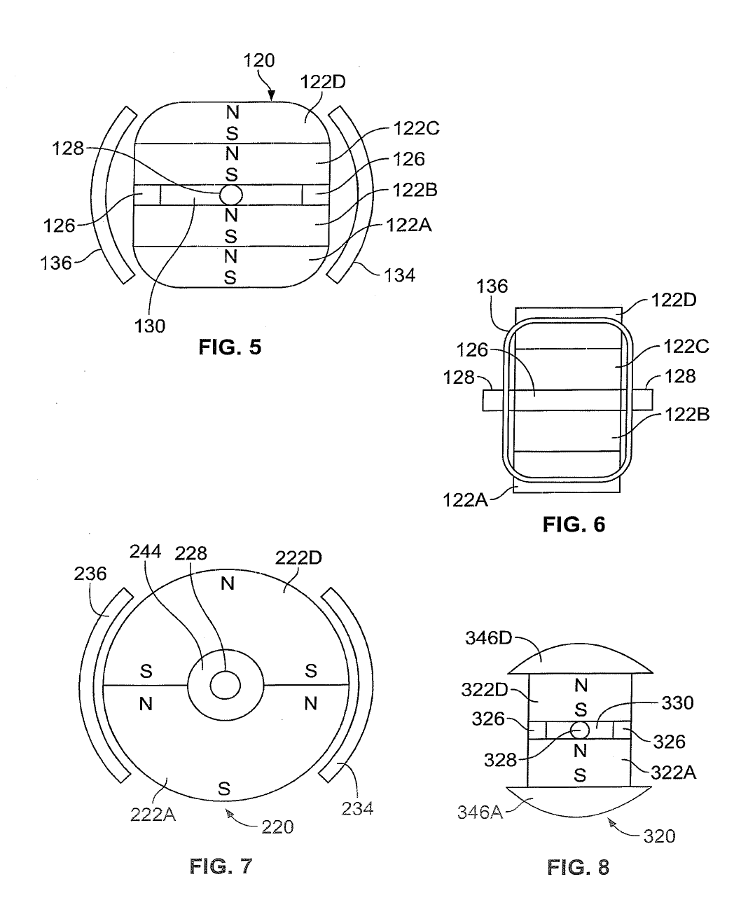

Referring to FIGS. 5 and 6, components corresponding to those shown in FIGS. 1-4 will have the same reference numerals but increased by 100. As before, a contiguous stack of remote permanent magnets 122A and 122B are spaced from the magnetic stack 122C and 122D by spacers 126, which straddle blade 130 with its supporting shaft 128. In this embodiment the outside corners of permanent magnets 122A and 122D are rounded to provide more intimate clearance from windings 134 and 136.

Diametrically opposed windings 134 and 136 lie on a common cylindrical plane that is coaxial with shaft 128 in order to provide more intimate clearance from armature 120. Each of the windings 134 and 136 are formed as four-sided loops, each loop having an opposite pair of circumferential legs connecting through rounded corners to a parallel pair of axial legs.

A rotor (not shown) may be built with a structure similar to armature 120 and placed in a coaxial position, axially spaced from the armature. As before the permanent magnets in the spinning rotor will cause armature 120 to spin in synchronism. The changing magnetic flux in windings 134 and 136 produces an EMF so the arrangement can act as an efficient AC generator.

Referring to FIG. 7, components corresponding to those shown in FIGS. 1-4 will have the same reference numerals but increased by 200 In this embodiment armature 220 is a split cylindrical drum formed of two permanent magnets 222A and 222D each having a semicylindrical recess for embracing cylindrical mandrel 244 and its integral shaft 228.

Windings 234 and 236 are the same as previously mentioned windings 134 and 136 of FIG. 5. As before the permanent magnets in an axially spaced spinning rotor (not shown) will cause armature 220 to spin and apply a changing magnetic flux in windings 234 and 236 to produce an EMF so the arrangement can act as an efficient AC generator.

Referring to FIG. 8, components corresponding to those shown in FIGS. 1-4 will have the same reference numerals but increased by 300 In this embodiment armature 320 has a pair of permanent magnets 322A and 322D each in the shape of a rectangular prism and separated by spacers 326, which straddle blade 330 with its supporting shaft 328.

Pole pieces 346A and 346D, made of soft iron, will be attached to the outside faces of permanent magnets 322A and 322D, respectively. Pole pieces 346A and 346D will have the shape of a section of a cylinder and will thus reduce the air gap to the windings (not shown) placed circumferentially around armature 320. As before, these windings (e.g. windings 134 and 136 of FIG. 5) allow operation as an efficient AC generator.

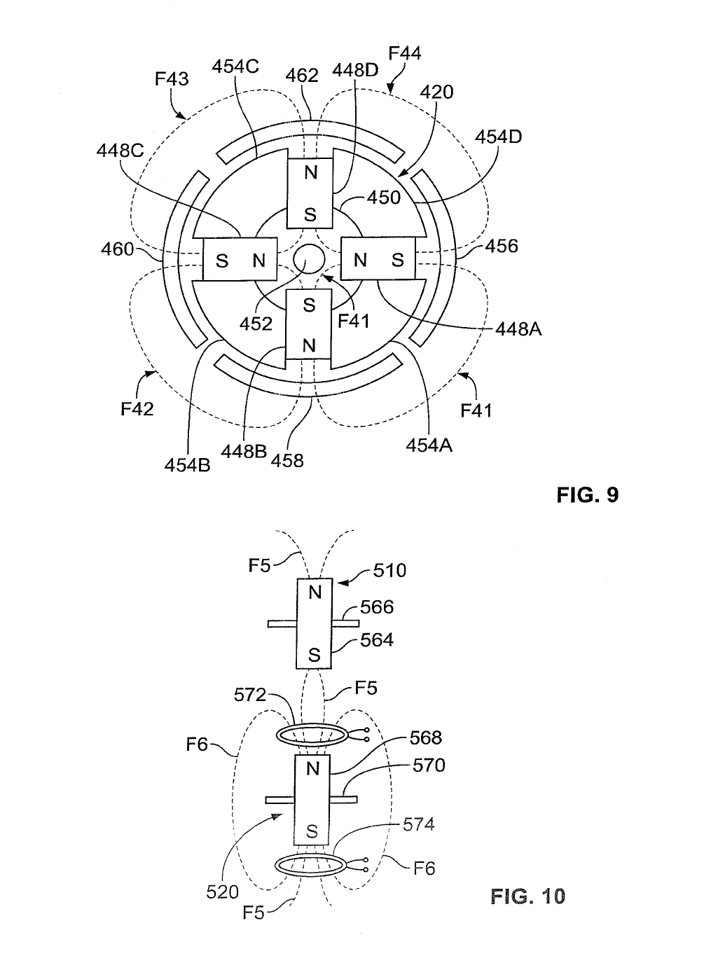

Referring to FIG. 9, armature 420 has four equiangularly spaced permanent magnets 448A, 448B, 448C and 448D, shown for the moment in the three o'clock, six o'clock, nine o'clock and twelve o'clock positions, respectively. Corresponding slots in steel mandrel 450 support magnets 448A, 448B, 448C and 448D, which have mounted between them quarter-cylindrical braces 454A, 454B, 454C and 454D made of non-ferromagnetic material. Mandrel 450 is supported on concentric shaft 452.

Windings 456, 458, 460 and 462 are shown mounted around armature 420 at the three o'clock, six o'clock, nine o'clock and twelve o'clock positions, respectively. Windings 456, 458, 460 and 462 lie on a common cylindrical plane that is coaxial with shaft 452. Each of the windings 456, 458, 460 and 462 are formed as four-sided loops, each loop having an opposite pair of circumferential legs connecting through rounded corners to a parallel pair of axial legs (similar to windings 134 and 136 of FIGS. 5 and 6).

In the orientation shown in FIG. 9, the magnetic axes of magnets 448A, 448B, 448C and 448D point horizontally to the left, vertically down, horizontally to the right, and vertically up, respectively. Intra-armature, magnetic flux is linked as follows: (1) flux lines F41 flowing from the north pole of magnet 448B to the south pole of magnet 448A and from the north pole of magnet 448A to the south pole of magnet 448B; (2) flux lines F42 flowing from the north pole of magnet 448B to the south pole of magnet 448C and from the north pole of magnet 448C to the south pole of magnet 448B, (3) flux lines F43 flowing from the north pole of magnet 448D to the south pole of magnet 448C and from the north pole of magnet 448C to the south pole of magnet 448D; and (4) flux lines F44 flowing from the north pole of magnet 448D to the south pole of magnet 448A and from the north pole of magnet 448A to the south pole of magnet 448D.

Armature 420 will be cooperate with a complementary rotor (not shown). This rotor will have essentially the same structure as armature 420, except the two will be shifted 90° with respect to each other. Each of the four magnets of the rotor will pair with one of the four magnets 448A, 448B, 448C and 448D, with each pair being anti-parallel and thus magnetically attracting. Accordingly, rotation of the rotor will cause synchronous rotation of armature 420.

Windings 456, 458, 460 and 462 will simultaneously receive maximum flux linkage followed by a simultaneous reversal of the magnetic flux. Thus by properly interconnecting them, these windings 426, 458, 460 and 462 will be in phase and will operate as an efficient AC generator at a frequency that is twice the armature's rpm.

Referring to FIG. 10, rotor 510 is schematically illustrated as permanent magnet 564 rotatably mounted on shaft 566. Armature 520 is schematically illustrated as permanent magnet 568 rotatably mounted on shaft 570. Windings 572 and 574 are mounted on opposite sides of armature 520, facing each other.

When permanent magnet 564 is aligned as shown, magnet 568 will align with magnet 564 due to their magnetic attraction. When magnet 564 rotates 180° its magnetic field will reverse and magnet 568 will likewise rotate 180°. Accordingly, magnet 568 will rotate synchronously with magnet 564. The magnetic linkage between magnets 564 and 568 is shown by flux lines F5, which will link through both windings 572 and 574. However, magnet 568 will link with windings 572 and 574 with independent flux lines F6. Thus as before, magnet 568 will amplify the magnetic field so that windings 572 and 574 will both have a greater EMF and will operate as an efficient AC generator.

It will be appreciated that spinning magnet 564 can be replaced with an electromagnet driven by an alternating current. For example, the magnetic axis of the electromagnet can intersect the axis of shaft 570. The alternating magnetic field from this electromagnet effectively presents a north pole that is periodically replaced with a south pole. This magnetic reversal will change the prior magnetic attraction of magnet 568 to repulsion. Consequently, magnet 568 will periodically flip 180°. This flipping of magnet 568 can occur in either direction, clockwise or counterclockwise. However, for practical angular speeds, the moment of inertia of magnet 568 will cause it to rotate in the same direction from cycle to cycle. It will be appreciated that the particular direction of rotation of the magnet 568 is not significant because the output of windings 572 and 574 will have the same magnitude regardless of the direction of rotation.

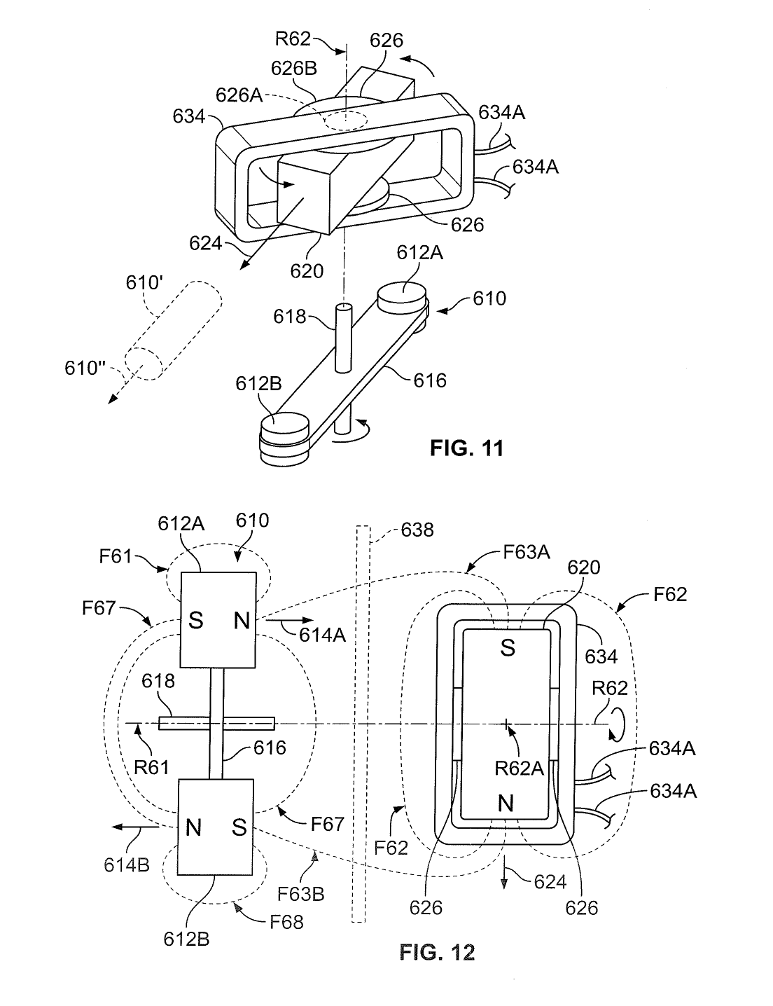

Referring to FIGS. 11 and 12, sender 610 has a pair of permanent magnets 612A and 612B mounted on opposite ends of rotor arm 616, which is rotatably supported on axle 618. Rotation of axle 618 causes the pair of magnetic devices 612A and 612B to orbit about axis of rotation R61 (basically the axis of rotation for the magnetic field of sender 610). The magnetic axes 614A and the 614B of magnets 612A and 612B are parallel to the axis of rotation R61 of axle 618, but are poled in opposite directions and are therefore referred to as being anti-parallel.

On the other side of non-ferromagnetic barrier 638, winding 634 has a rectangular opening and it is wound about an axis that is transverse to axis R62 of axle 618. Remote element 620 is a permanent magnet with a magnetic axis 624 and acts as an armature that is rotatably mounted inside the rectangular opening of winding 634, which winding has output leads 634A.

Armature 620 is sandwiched between an opposing pair of bearings 626, each having an inner race 626A attached to armature 620, and an outer race 626B attached to the inside of winding 634. Bearings 626 allow armature 620 to rotate about axis of rotation R62, which is shown coaxial with axle 618, although in some embodiments axle 618 can be radially offset and/or skewed relative to axis R61. Armature 620 is balanced relative to axis R62 and has along this axis a center of gravity R62A, also referred to as a center of rotation encompassed by winding 634.

To facilitate an understanding of the principles associated with the foregoing apparatus, its operation will be briefly described. Rotor 610 and armature 620 will initially align as shown in FIGS. 11 and 12. Specifically, magnetic axis 624 will be parallel to rotor arm 616 with (a) the north pole of magnet 612A pointing to the end of magnet 620 constituting its south pole, and (b) the south pole of magnet 612B pointing to the end of magnet 620 constituting its north pole. The foregoing alignment is that expected with ordinary magnetic attraction.

Lines of flux F61 and F68 are shown making a circuit between the north and south poles of permanent magnet 612A and 612B, respectively. Lines of flux F67 are shown extending from the north pole of magnet 612A (magnet 612B) to the south pole of magnet 612B (magnet 612A). Also, lines of flux F62 are shown making a circuit between the north and south poles of permanent magnet 620. In addition, flux line F63A links between the north pole of magnet 612A and the south pole of magnet 620, while flux line F63B links between the north pole of magnet 620 and the south pole of magnet 612B.

In operation, shaft 618 will be rotated by an external mechanical power source (not shown), such as a hand crank, a motor (diesel, gasoline, electrical, etc.), a windmill, a steam turbine, etc. Consequently, the magnets 612A and 612B will orbit about the axle 618 to produce a rotating magnetic field that causes flux lines F63A and F63B to rotate about the axis of rotation R61. This rotating magnetic field produces a torque on permanent magnet 620, causing it to rotate about axis R62. Provided the magnetic fields of magnets 612A, 612B and 620 are strong enough, both magnets will rotate at the same speed without slippage, but with a phase angle differential sufficient to produce the driving torque.

With magnetic components 610 and 620 rotating, flux lines F62, F63A and F63B will rotate as well relative to stationary winding 634. Faraday's and Lenz's law indicate that the electromotive force (EMF) in winding 634 will be proportional to the rate of change of magnetic flux through the coil, times the number of turns in the coil. As flux lines F62, F63A and F63B rotate, the linkage through winding 634 will periodically reverse and produce a sinusoidal EMF. Therefore, the foregoing arrangement will act as an efficient AC generator with the current induced in winding 634 supplying electrical power to lines 634A and 634B.

The magnetic linkage between magnets 612A and 612B and winding 634 (flux lines F63A and F63B) is a relatively small percentage of the total magnetic linkage through that winding. On the other hand, as suggested by FIG. 12, the linkage from magnet 620 involves a relatively high flux density (flux lines F62) compared to that from magnetic device 610 (flux lines F63A and F63B). Because magnet 620 is adjacent to winding 634 and rotates synchronously with magnetic sender 610, magnet 620 effectively magnifies the magnetic flux produced by magnetic device 610. Greater electrical power is produced as a result of this magnified flux density.

It will be appreciated that sender 610 can be replaced with an electromagnet driven by an alternating current. Such a device is shown in phantom in FIG. 11 as alternative electromagnet 610′. The magnetic axis 610″ of electromagnet 610′ is shown intersecting the axis R62. The magnetic axis of electromagnet 610′ is shown lying at an angle of approximately 30° to the plane of winding 634, although various other angular orientations are possible in other embodiments.

The alternating magnetic field from electromagnet 610′ effectively presents a north pole alternating with a south pole. This magnetic reversal will change a recent magnetic attraction of magnet 620 to repulsion. Consequently, magnet 568 will flip 180°. This flipping of magnet 620 can occur in either direction, clockwise or counterclockwise. However, for practical angular speeds, the moment of inertia of magnet 620 will cause it to rotate in the same direction from cycle to cycle. It will be appreciated that the particular direction of rotation of the magnet 620 is not significant because the output of winding 634 will have the same magnitude regardless of the direction of rotation.

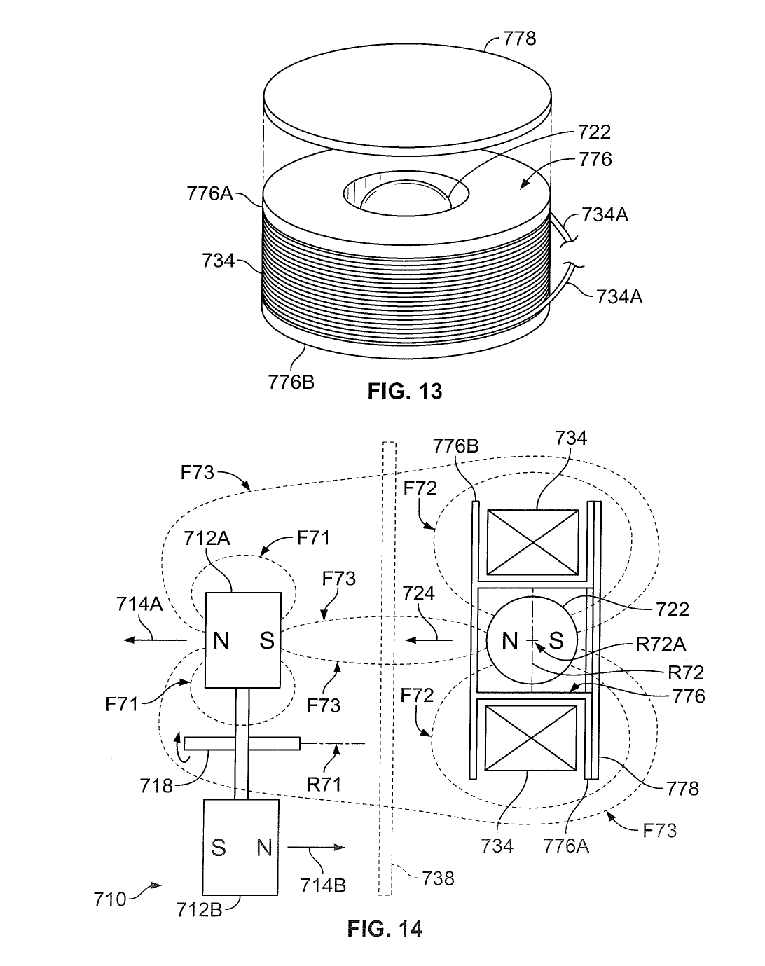

Referring to FIGS. 13 and 14, sender 710 is the same as previously described sender 610 of FIG. 12, and has a pair of permanent magnets 712A and 712B mounted on opposite ends of rotor arm 716, which arm is rotatably supported on axle 718. The magnetic axes 714A and 714B of magnets 712A and 712B are parallel to the axis of rotation of axle 718, but are poled in opposite directions and are therefore referred to as being anti-parallel.

On the other side of non-ferromagnetic barrier 738, winding 734 is wound around the hollow cylindrical core of spool 776 between flanges 776A and 776B. The axis of winding 734 is shown parallel to rotational axis R71, but may be skewed in some embodiments.

Spherical permanent magnet 722 is mounted in the cylindrical chamber at the center of spool 776. This magnetic ball 722 is magnetized along diametric magnetic axis 724. Magnet 722 acts as an armature and has, among other freedoms, the freedom to rotate along any diametric axis passing through its center R72A (also referred to as a center of rotation). The magnetic ball 722 is captured inside its chamber by lid 778, which is secured in place by glue or other means.

To facilitate an understanding of the principles associated with the foregoing apparatus, its operation will be briefly described. Magnet 712A is shown in FIG. 14 at a 12 o'clock position, that is, swung closest to ball 722 with its magnetic axis 714A and rotational axis R71 in the same plane as center R72A. In this position, rotor 710 and ball 720 will initially align as shown in FIG. 14, that is, with the ball's magnetic axis 724 pointing toward magnet 712A. In this embodiment center R72A is spaced radially further from rotor axis R71 than is magnetic axis 714A. Consequently, the ball's magnetic axis 724 is shown in FIG. 14 pointing downwardly. The foregoing alignment is that expected with ordinary magnetic attraction. In embodiments where ball 722 is closer radially to axis R72, the ball's magnetic axis 724 may have a level or a higher angle of elevation.

Lines of flux F71 are shown making a circuit between the north and south poles of permanent magnet 712A. Lines of flux F72 are shown making a circuit between the north and south poles of permanent magnet 722. In addition, flux lines F73 link between the south (north) pole of magnet 712A and the north (south) pole of magnet 722. Flux linkage exists between magnet 712B and magnetic ball 722, but because of the greater spacing this linkage is much weaker and so, for the sake of clarity, no lines of flux are shown for magnet 712B.

It will be appreciated that if shaft 718 is rotated 180° magnet 712B will swap positions with magnet 712A. In effect, the magnetic fields will reverse, and the strongest magnetic pole near magnetic ball 722 will be the north pole of magnet 712B, causing magnetic ball 722 to flip 180° about its diametric axis R72. At relatively low angular speeds, magnetic ball 722 can flip in either direction, rotating either clockwise or counterclockwise. At higher, more practical angular speeds, the moment of inertia of magnetic ball 722 will cause it to rotate in the same direction about axis R72, since rapid reversals will not be feasible. It will be appreciated that the particular direction of rotation of the ball 722 is not significant because the output of coil 734 will have the same magnitude regardless of the direction of rotation.

Therefore, as shaft 718 is rotated by an external mechanical power source (not shown), magnets 712A and 712B will orbit about the axle axis R71 to produce a rotating magnetic field that causes magnetic ball 722 to continuously realign and rotate about its axis R72. In most practical embodiments, the speed of rotation and the mass of ball 722 will cause the ball to rotate fairly smoothly with little fluctuation in angular speed, although speed fluctuation will not prevent magnetic induction into coil 734. It will be noticed that the axis of rotation R72 is skewed relative to axis R71. In particular, “skewed” axes as used herein means: (a) if the axes are coplanar, they are neither parallel nor perpendicular, or (b) if the axes are not coplanar, a perpendicular projection of one onto the other is neither parallel not perpendicular.

With magnetic ball 722 spinning about axis R72, flux lines F72 will rotate relative to stationary winding 734. Flux lines F73 (as well as the flux lines associated with magnet 712B) will rotate as well and although this magnetic linkage will cause induction in coil 734, this effect will be less than that caused by magnetic pole 722.

As before, Faraday's and Lenz's law indicate that the electromotive force (EMF) in winding 734 will be proportional to the rate of change of magnetic flux through the coil, times the number of turns in the coil. As flux lines F72 (and flux lines F73 and the flux associated with magnet 712B) rotate, the linkage through winding 734 will periodically reverse and produce an alternating, essentially sinusoidal EMF. Therefore, the foregoing arrangement will act as an efficient AC generator with the current induced in winding 734 supplying electrical power to lines 734A and 734B.

The linkage from magnet 722 involves a relatively high flux density (flux lines F72) compared to that from magnetic device 710. Because magnet 722 is adjacent to winding 734 and rotates synchronously with magnetic sender 710, magnet 722 effectively magnifies the magnetic flux produced by magnetic device 710. Greater electrical power is produced as a result of this magnified flux density.

As noted before, the angle of elevation of the ball's magnetic axis 724 can change to accommodate the position of sender 710. The axis of rotation R72A remains transverse to magnetic axis 724 and so both may be considered changeable (i.e., axis R72A may be considered a changeable axis of rotation).

In some cases, the sender axis R71 will be aligned, or nearly aligned, with the center of rotation R72A of magnetic ball 722. In that case, the ball's axis of rotation R72 will tend to align with the sender axis R71. Such alignment will reduce the output because of a corresponding reduction in the magnitude of fluctuations in the magnetic linkage through winding 734, although some fluctuations will remain due to nutation, vibration or asymmetries in ball 722.

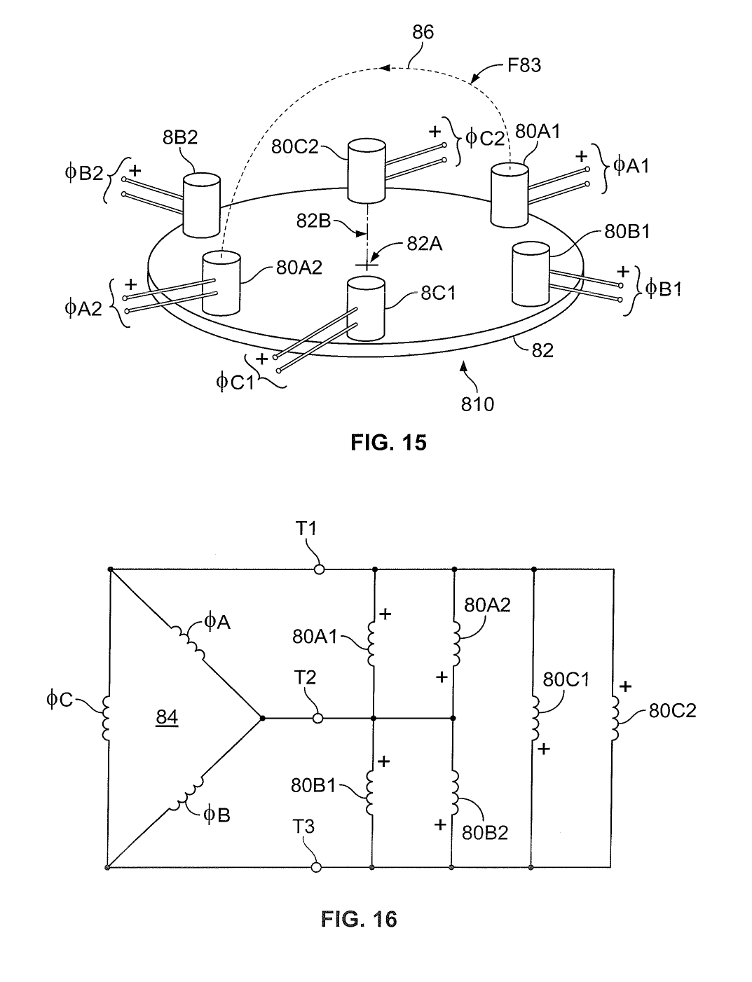

Referring to FIGS. 15 and 16, an alternate sender 810 is illustrated. Sender 810 has no moving parts and uses stationary electromagnets as local elements to create a rotating electromagnetic field. Specifically, electromagnets 80A1, 80B1, 80C1, 80A2, 80B2, and 80C2 are mounted on platform 82 with their magnetic axes perpendicular to the platform. Electromagnets 80A1, 80B1, 80C1, 80A2, 80B2, and 80C2 are equiangularly spaced around center 82A and are shown located at the 2, 4, 6, 8, 10, and 12 o'clock positions respectively.

Platform 82 is shown as a circular disk although other outlines may be used instead Platform 82 is made of a non-ferromagnetic material such as plastic, ceramic, etc., in order to transmit a magnetic field further from platform 82 by avoiding the shunting that would otherwise occur with a nearby ferromagnetic material.

Diametrically opposed electromagnets (e.g. electromagnets 80A1 and 80A2) are connected in parallel to act as a cooperating pair. Thus, this sender has three cooperating pairs of electromagnets and so may be deemed to have effectively a trio of electromagnets (i e. electromagnet pairs 80A1-80A2, 80B1-80B2, and 80C1-80C2). Each of the electromagnets are wound so that if a positive potential is applied to the plus (“+”) terminal the electromagnet will be magnetized with its north pole directed upwardly.

A three-phase source 84 of electrical power is shown in FIG. 16 as a generator (or transformer) connected in a delta configuration, although other embodiments may use a Y configuration. Source 84 is connected as follows:
(1) phase □A is connected between terminals T1 and T2,
(2) phase □B is connected between terminals T2 and T3, and
(3) phase □C is connected between terminals T3 and T1.

The electromagnets are connected as follows: (1) electromagnets 80A1 and 80A2 are connected in parallel between terminals T1 and T2, with the electromagnets' plus terminals connected to terminals T1 and T2, respectively; (2) electromagnets 80B1 and 80B2 are connected in parallel between terminals T2 and T3, with the electromagnets' plus terminals connected to terminals T2 and T3, respectively; and (3) electromagnets 80C1 and 80C2 are connected in parallel between terminals T3 and T1, with the electromagnets' plus terminals connected to terminals T3 and T1, respectively.

With the foregoing connections, for each of the complementary pair of electromagnets, the two electromagnets are out of phase 180° and will therefore be oppositely poled. Thus, when one member of the complementary pair has its north pole up, the other will have its north pole down. FIG. 15 illustrates a situation with only the electromagnet pair 80A1 and 80A2 energized and with a resulting magnetic flux line F83 linked between the upper ends of this electromagnet pair. Because the electromagnets 80A1 and 80A2 are driven by oppositely phased alternating current, the electromagnetic field 86 over the center 82A (intersecting central vertical axis 82B) will have for one half cycle the illustrated horizontal orientation (two o'clock to eight o'clock orientation), but will have the opposite orientation for the following half cycle. Also, the magnitude of field 86 will vary sinusoidally.

In normal operation, electromagnetic pair 80A1 and 80A2 will produce only one component of the net electromagnetic field, and will combine under the laws of vector addition with the other two components, whose orientation will be displaced ±120° from field 86. Since the three-phase power has a phase-to-phase differential of 120°, the net electromagnetic field intersecting central vertical axis 82B will rotate 360° at the same frequency as the common frequency of phases □A, □B, and □C.

The foregoing sender 810 can replace any of the senders shown in the embodiments of FIGS. 1-4, 11 and 12. Basically, the replacement sender of FIG. 15 will be placed in the same location as the other sender and with its axis 82B having the same alignment as the prior axis of rotation Specifically, axis 82B will have the same alignment as: (1) axis R1 of FIG. 1; and (2) the axis of shaft 628 of FIGS. 11 and 12. As before, this axial alignment can be skewed somewhat, and/or radially displaced in various embodiments. It will be appreciated that the replaced senders and the replacement sender will generate a rotating magnetic field that is capable of rotating the associated armature.

It is appreciated that various modifications may be implemented with respect to the above described embodiments. The armature coils can be arranged to occupy quadrants or different angular domains depending upon whether the output is DC or AC with single or multiple phases. In addition, the windings can be rectangular, circular, oval, polygonal, or other configurations. Also, the coils can be supported by a variety of frames or can be attached in various manners to the inside of an armature housing. While permanent magnets are disclosed, in some cases they may be replaced with electromagnets or combinations of permanent magnets and electromagnets. Also a variety of structures may be used to support the magnets and electromagnets of the rotor and armature and these structures can include laminations to reduce eddy currents. While a single rotor is shown driving a single armature, in some embodiments a large capacity rotor will drive multiple armatures. These multiple armatures can be placed on opposite sides of the rotor or can be disposed in different orthogonal or azimuthal positions. In some cases a rotor will drive an intermediate rotor, which will in turn drive an armature that can produce current through its associated coils. In some cases the system will be operated in reverse with the armature acting as a motor driven by its associated coils to then produce a torque that rotates the armature. It will be appreciated that the size of the components, the gauge of wire in windings, the number of turns in a winding, the strength of a magnet or electromagnet, and the like, can be varied depending upon the desired power output, and overall capacity of the system.

Obviously, many modifications and variations of the present invention are possible in light of the above teachings. It is therefore to be understood that within the scope of the appended claims, the invention may be practiced otherwise than as specifically described.

1. An energy transfer system comprising:
a sender having at least one local element for producing a magnetic field, said magnetic field being rotatable by said sender;
an armature having at least one remote element for interacting with said magnetic field, said armature being arranged to be angularly driven in response to rotation of said magnetic field; and
at least one winding disposed about said armature for interacting with said at least one remote element, a current being induced in said at least one winding in response to rotation of said armature and said at least one remote element.

2. An energy transfer system according to claim 1 wherein said armature is axially spaced from said sender.

3. An energy transfer system according to claim 1 comprising:
a non-ferromagnetic barrier separating and extending transversely between said sender and said armature.

4. An energy transfer system according to claim 1 wherein said at least one local element comprises a local permanent magnet.

5. An energy transfer system according to claim 4 wherein said sender comprises a rotor having a local axis of rotation, said rotor carrying said local permanent magnet.

6. An energy transfer system according to claim 5 wherein said local permanent magnet has a magnetic axis that is transverse to said local axis of rotation.

7. An energy transfer system according to claim 1 wherein said at least one remote element comprises a remote permanent magnet.

8. An energy transfer system according to claim 7 wherein said armature has a remote axis of rotation, said remote permanent magnet having a magnetic axis that is transverse to said remote axis of rotation.

9. An energy transfer system according to claim 8 wherein said at least one winding comprises,
an angularly spaced plurality of windings mounted about said armature to magnetically link with said remote permanent magnet.

10. An energy transfer system according to claim 9 wherein said at least one local element comprises a local permanent magnet, said sender comprising:
a rotor having a local axis of rotation aligned with said remote axis of rotation, said rotor carrying said local permanent magnet.

11. An energy transfer system according to claim 10 wherein said local permanent magnet has a magnetic axis that is transverse to said remote axis of rotation.

12. An energy transfer system according to claim 1 wherein said local element has a spaced pair of magnetic devices with anti-parallel magnetic axes.

13. An energy transfer system according to claim 12 wherein said pair of magnetic devices are mounted to orbit around an axis of rotation that is parallel to the magnetic axes of the magnetic devices.

14. An energy transfer system according to claim 13 wherein said pair of magnetic devices are both permanent magnets.

15. An energy transfer system according to claim 1 wherein said at least one remote element comprises a magnetic ball mounted with freedom to spin about a changeable axis.

16. An energy transfer system according to claim 15 said armature comprises:
a chamber for containing said ball, said at least one winding being wound around said chamber.

17. An energy transfer system according to claim 15 wherein said ball has a magnetic axis and is free to rotate about the changeable axis, which is transverse to said magnetic axis.

18. An energy transfer system according to claim 1 wherein said sender is operable to rotate the magnetic field about a sending axis of rotation, said at least one remote element being mounted to rotate about a remote rotational axis that is skewed relative to said sending axis.

19. An energy transfer system according to claim 1 wherein said sender is operable to rotate the magnetic field about a sending axis of rotation, said at least one remote element having in it a center of rotation that is radially spaced from said sending axis of rotation.

20. An energy transfer system according to claim 1 wherein said at least one local element comprises at least one electromagnet.

21. An energy transfer system according to claim 1 wherein said at least one local element comprises a pair of oppositely poled electromagnets

22. An energy transfer system according to claim 1 wherein said at least one local element comprises a trio of electromagnets spaced equiangularly and driven by three phase power to produce and rotate said electromagnetic field.

23. An energy transfer system according to claim 1 wherein said at least one remote element is mounted for rotation about a center of rotation, said at least one winding encompassing the center of rotation of said at least one remote element.

24. A method employing a winding and a local and a remote element for transferring energy, comprising the steps of:
using the local element to send a rotating magnetic field;
placing the remote element in a position to be angularly driven by the rotating magnetic field, the remote element being axially spaced from the local element;
disposing the winding about the remote element in a position to induce a current in the winding in response to rotation of the remote element.

25. A method according to claim 24 comprising the step of:
placing between the remote and the local element a non-ferromagnetic barrier that separates and extends transversely between them.

26. A method according to claim 24 wherein the local element employs a local permanent magnet, the step of using the local element being performed by rotating the local permanent magnet about a local axis of rotation to produce the rotating magnetic field.

27. A method according to claim 26 wherein the step of using the local element is performed with the local permanent magnet having its magnetic axis transverse to the local axis of rotation.

28. A method according to claim 24 wherein the remote element comprises a remote permanent magnet rotatable about a remote axis of rotation, the step of placing the remote element being performed with the remote permanent magnet having its magnetic axis transverse to the remote axis of rotation.

29. A method according to claim 28 wherein the step of disposing the winding is performed to magnetically link it with the remote permanent magnet.

30. A method according to claim 29 wherein the local element employs a local permanent magnet, the step of using the local element being performed by rotating the local permanent magnet about a local axis of rotation to produce the rotating magnetic field.

31. A method according to claim 30 wherein the step of using the local element is performed with the local permanent magnet having its magnetic axis transverse to the local axis of rotation.

32. A method according to claim 24 wherein said local element has a spaced pair of magnetic devices with anti-parallel magnetic axes, the step of placing the remote element in a position to be angularly driven being performed to cause said pair of magnetic devices to orbit around an axis of rotation that is parallel to the magnetic axes of the magnetic devices.

33. A method according to claim 24 wherein said remote element comprises a magnetic ball, the step of placing the remote element being performed by giving said ball freedom to spin about a changeable axis.

34. A method according to claim 33 wherein said ball has a magnetic axis and is free to rotate about the changeable axis, which is transverse to said magnetic axis.

35. A method according to claim 24 wherein the step of using the local element to send a rotating magnetic field is performed by rotating the magnetic field about a sending axis of rotation, the step of placing the remote element in a position to be angularly driven is performed by rotating the remote element about a remote rotational axis that is skewed relative to said sending axis.

36. A method according to claim 24 wherein the step of using the local element to send a rotating magnetic field is performed by rotating the magnetic field about a sending axis of rotation, the step of placing the remote element in a position to be angularly driven is performed by rotating it about a center of rotation that is radially spaced from said sending axis of rotation.

37. An energy transfer system comprising:
a rotor having a local axis of rotation, said rotor carrying at least one local permanent magnet for producing a magnetic field, said local permanent magnet having a magnetic axis that is transverse to said local axis of rotation, said magnetic field being rotatable by said rotor;
an armature axially spaced from said rotor and having at least one remote permanent magnet for interacting with said magnetic field, said armature having a remote axis of rotation aligned with said local axis of rotation, said remote permanent magnet having a magnetic axis that is transverse to said remote axis of rotation, said armature being arranged to be angularly driven in response to rotation of said magnetic field;
an angularly spaced plurality of windings mounted about said armature to magnetically link with said remote permanent magnet, a current being induced in said plurality of windings in response to rotation of said armature and said at least one remote permanent magnet; and
a non-ferromagnetic barrier separating and extending transversely between said sender and said armature.
